(19) United States
(12) Patent Application Publication
(10) Pub. No.: US 2026/0018590 A1
(43) Pub. Date: Jan. 15, 2026

(54) BATTERIES CONTAINING TRANSITION METAL CHLORIDES

(71) Applicant: The Trustees of Boston College, Chestnut Hill, MA (US)

(72) Inventors: Alexis Grimaud, Cambridge, MA (US); Michael Spencer, Newton, MA (US)

(21) Appl. No.: 19/263,047

(22) Filed: Jul. 8, 2025

Related U.S. Application Data
(60) Provisional application No. 63/670,644, filed on Jul. 12, 2024.

(51) Int. Cl. H01M 4/136; H01M 4/02; H01M 10/0525; H01M 10/0568; H01M 10/0569

(52) U.S. Cl. CPC H01M 4/136; H01M 10/0525; H01M 10/0568; H01M 10/0569; H01M 2004/027; H01M 2004/028; H01M 2300/0028

(57) ABSTRACT

Disclosed is a battery having a positive electrode, a negative electrode, and an electrolyte. At least one of the positive electrode and the negative electrode contains a lithium or sodium compound of A₂MCl₄, in which A is Li or Na and M is Ti, V, Cr, Mn, Fe, or Co. The electrolyte has a salt concentration of at least 3 mol/L.

### CROSS REFERENCE TO RELATED APPLICATION

The application claims the benefit of and priority to U.S. Application Ser. No. 63/670,644 filed on Jul. 12, 2024, the entire content of which is incorporated by reference.

### GOVERNMENT SUPPORT

The invention was made with government support under Grant Number DMR2326843 awarded by the National Science Foundation. The government has certain rights in the invention.

### FIELD OF INVENTION

The disclosure relates to electrochemical batteries and electrode materials.

### BACKGROUND

Electrochemical reactions enable a broad range of technologies, particularly electrochemical energy storage devices that power electric vehicles and portable electronics.

Transition metal (TM) chalcogenides (oxides and sulfides) have been used as cathode materials in lithium- and sodium-ion batteries due to their electrochemical response leading to electrochemical reactions including intercalation, conversion or displacement reactions when reacting with lithium or sodium. Their chemical compositions and crystal structures are critical to the performance as electrode materials. Following the pioneering works by Whittingham and Goodenough, layered or spinel TM chalcogenides remain the stellar materials for the reversible (de)intercalation of Li⁺. See Whittingham, Science 1976, 192 (4244), 1126-1127 (1979), available at the Digital Object Identifier (DOI) system having an address at //doi.org/10.1126/science.192.4244.1126; and Goodenough, Acc Chem Res 46 (5), 1053-1061 (2013) available at //doi.org/10.1021/ar2002705.

Nevertheless, TM chalcogenides suffer from electronic conductivity and structural instability resulted from (de)intercalation and displacement reactions. Their utility in electrochemical batteries is limited further by their scalability issues. Other TM binary materials, e.g. nitrides, phosphides, and fluorides, undergo various conversion reactions with lithium, contributing to capacity loss and stability issues. Studies have revealed subtle deviations from conversion reaction for binary compounds such as FeF₃ which initially react with lithium following a displacement reaction and the formation of LiₓFe_{y}F₃. Similarly, binary TM phosphides such as Ni₂P or FeP_{y} (y=1, 2 or 4) were shown to react with lithium following a stepwise process involving the formation of a lithiated intermediate (Li_{2.4}NiP₂ and LiFeP, respectively).

On the other hand, ternary pnictides Li-TM-Pn systems (with TM=V, Ti, Fe or Mn and Pn=N, P or As) were shown to undergo an amorphization/recrystallization of the structure upon cycling, besides desirable Li⁺ (de)intercalation.

Prior efforts largely left transition metal halides unexplored due to their heightened solubility in conventional liquid electrolytes.

There is a need to develop an electrochemical material that is stable and highly active in electrodes for use in rechargeable batteries including molten-salt batteries, solid-state batteries, and liquid-state batteries.

### SUMMARY

This invention is based on an unexpected discovery of rechargeable batteries using lithium or sodium compounds as electrode materials and containing high concentrations of salts in electrolytes.

Accordingly, one aspect of this invention relates to batteries each containing a positive electrode, a negative electrode, and an electrolyte. In the batteries, the electrolyte has a salt concentration of at least 3 mol/L, and at least one of the positive electrode and the negative electrode contains a lithium or sodium compound of A₂MCl₄, in which A is Li or Na and M is Ti, V, Cr, Mn, Fe, or Co.

The batteries can have one or a combination of the following features.
(i) The lithium or sodium compound has a monoclinic structure, a spinel structure, an inverse spinel structure, or a defect rock-salt structure, each of which contains transition metal-chloride polyhedra connected in 1-dimensional (1D) chains or 3D networks.
(ii) The lithium or sodium compound contains 1D chains of edge-sharing octahedra.
(iii) The lithium or sodium compound is Li₂VCl₄, Li₂FeCl₄, Li₂MnCl₄, Li₂CoCl₄, Li₂NiCl₄, Li₂CrCl₄, Na₂TiCl₄, Na₂FeCl₄, Na₂MnCl₄, Na₂CoCl₄, Na₂CoCl₄, or Na₂CrCl₄.
(iv) The lithium or sodium compound is Li₂CoCl₄ or Na₂MnCl₄.
(v) The positive electrode or the negative electrode further contains A₆MCl₈.
(vi) The positive electrode contains Li₂CoCl₄, Na₂MnCl₄, or a combination thereof.
(vii) The anode contains lithium, sodium, graphite, or any combination thereof.
(viii) The electrolyte contains a salt selected from the group consisting of LiClO₄, LiPF₆, LiBF₄, LiSbF₆, LiCF₃SO₃, LiN(SO₂CF₃)₂, LiN(SO₂C₂F₅)₂, LiN(SO₂F)₂, LiC(SO₂CF₃)₃, Li[N(SO₂C₄F₉)(SO₂F)], LiAlO₄, LiAlCl₄, LiCl, LiI, lithium bis(oxalato)borate, lithium bis(fluorosulfonyl)imide (LiFSI), NaClO₄, NaPF, NaBF₄, NaSbF₆, NaCF₃SO₃, NaN(SO₂CF₃)₂, NaN(SO₂C₂F₅)₂, NaN(SO₂F)₂, NaC(SO₂CF₃)₃, Na[N(SO₂C₄F₉)(SO₂F)], NaAlO₄, NaAlCl₄, NaCl, Nal, sodium bis(oxalato)borate, sodium bis(fluorosulfonyl)imide (NaFSI), or a combination thereof.
(ix) The salt in the electrolyte is dissolved or suspended in a carbonate, an ether, an ester, a ketone, a nitrile, or a combination thereof.
(x) The electrolyte is LiFSI or NaFSI dissolved in dimethyl carbonate (DMC) or dimethoxyethane (DME).
(xi) The electrolyte has a salt concentration of at least 4 mol/L.
(xii) The electrolyte has a salt concentration of 4.5 mol/L to 10 mol/L.
(xiii) The electrolyte is a lithium or sodium salt dissolved in a non-aqueous solvent having a salt concentration of at least 4 mol/L.
(xiv) The electrolyte has a salt concentration of 4.5 mol/L to 10 mol/L.
(xv) The battery is chargeable and dischargeable.

The details of the invention are set forth in the definitions and the detailed description below. Other features, objects, and advantages of the invention will be apparent from the following actual examples and claims.

### BRIEF DESCRIPTION OF THE DRAWINGS

FIG. 1 shows crystal structures and XRD patterns with Le Bail fitting of a) Li₂CrCl₄, b) Li₂MnCl₄, c) Li₂FeCl₄, and d) Li₂CoCl₄. The three lines from top to bottom represent the observed, calculated, and difference patterns, respectively. Vertical tick marks indicate the reflection positions.

FIG. 2 shows a) galvanostatic cycling of Li₂CoCl₄ at C/10 and 55° C. Galvanostatic intermittent titration technique (GITT) results for Li₂CoCl₄ limited to the transfer of b) 1 e⁻/f.u. and c) 2 e⁻/f.u. The dashed lines correspond to the Co²⁺⁰ redox potential.

FIG. 3 shows (a) crystal structure of Na₂MnCl₄ and (b) galvanostatic cycling of Na₂MnCl₄ in a high concentration Na-ion electrolyte consisting of 0.5:1 molar ratio between NaFSI and DME.

### DETAILED DESCRIPTION

The invention is based on a surprising discovery of using lithium or sodium TM halides as electrode materials together with high concentration electrolytes that stabilize the TM halides.

As described below in the Example section, it has been demonstrated that A₂MCl₄ compounds (A is Li or Na and M is Cr, Mn, Fe, Zr, or Co) are suitable for use in electrodes (e.g., cathodes) of lithium and sodium batteries having a superconcentrated electrolytes.

A₂MCl₄compounds combined with high concentration electrolytes are particularly useful owing to the specific electronegativities of Cl, Br, and I. The chlorides offer the highest redox potentials compared to the bromides and iodides, as well as greater theoretical gravimetric capacity.

Suitable transition metal chlorides include crystalline forms in a range of structural dimensionalities (defined by the connectivity of the transition metal chloride polyhedra) such as 0D with isolated TM chloride polyhedra, 1D chains of edge-sharing polyhedra (e.g., octahedra), and 3D with TM chloride polyhedra interconnected in all directions throughout the lattice. The structural dimensionality in some embodiment depends on the choice of A and M.

Among the three structures, Li₂MCl₄ compounds can be in the form of cubic inverse spinel or the cubic defect rocksalt-type structure.

An A₂MCl₄ compound typically has a conductivity in the range between 10⁻¹⁰ S cm⁻¹ and 10⁻¹ S cm⁻¹ (e.g., 10⁻⁹ to 10⁻² S cm⁻¹, 10⁻⁸ to 10⁻² S cm⁻¹, and 10⁻⁶ to 10⁻² S cm⁻¹) at 30° C.

Further, the A₂MCl₄ compound can have a charge capacity from 80 to 300 mAh g⁻¹ (e.g., 90 to 250 mAh g⁻¹, 100 to 200 mAh g⁻¹, and 120 to 180 mAh g⁻¹) at 30° C. and a discharge capacity from 80 to 300 mAh g⁻¹ (e.g., 90 to 250 mAh g⁻¹, 100 to 200 mAh g⁻¹, and 120 to 180 mAh g⁻¹) measured at 0.5 C.

A₂MCl₄ contains transition metal M that can be a single element or any combination. Further, it can be combined with any other electrode material in preparing a cathode or anode. Examples include Li₂CrCl₄, Li₂MnCl₄, Li₂FeCl₄, Li₂CoCl₄, Li₂CuCl₄, Na₂CrCl₄, Na₂MnCl₄, Na₂FeCl₄, Na₂CoCl₄, and Na₂CuCl₄. Preferably, A₂MCl₄ is contained in the cathode.

Not to be bound by any theory, Li₂CoCl₄in a cathode first reacts with one Li⁺ following a displacement reaction providing a reversible capacity of 125 mAh g⁻¹. This reaction is enabled by the formation of a Li₆CoCl₈ intermediate, which shares a similar anionic framework as pristine Li₂CoCl₄, ensuring the topotactic insertion of Li+ balanced by the Co²⁺/Co⁰ redox couple and the formation of metallic Co nanoparticles. It is believed that two criteria are therefore necessary to trigger the displacement reaction in A₂MCl₄ compounds: the presence of 1D chains of edge-sharing octahedra and availability of a metal-deficient intermediate. Numerous A₂MCl₄compounds of this invention show the universality of these design principles including lithium and Na materials by demonstrating a low-polarization, reversible displacement reaction. Examples include Li₂CoCl₄ (cycled in Li-based superconcentrated electrolyte) and Na₂MnCl₄ (cycled in Na-based superconcentrated electrolyte). In addition, structure-property is important to the reactivity of transition metal halides with alkali cations.

In preferred batteries of this invention, the cathode contains A₂MCl₄ as described above including Li₂CoCl₄ and Na₂MnCl₄.

On the other hand, the anode contains lithium, sodium, graphite, or any combination thereof. Examples include a lithium metal foil pressed on a current collector (e.g., a copper foil or mesh), a bare current collector,

Suitable electrolytes include a lithium or sodium salt dissolved in an organic solvent, having a concentration of at least 3 moles per liter (M), e.g., at least 4 M, at least 5 M, 3-20 M, 4-18 M, 4.5-15 M, 4.5-12 M, 4.5-10 M, 5-8 M, 5 M, and 7.5 M.

Lithium or sodium salts include imide salt with a fluorosulfonyl (FSO₂) group such as LiN(FSO₂)₂, LiN(FSO₂)(CF₃SO₂), LiN(FSO₂)(C₂F₅SO₂), and any combination thereof. The electrolyte can contain a cyclic carbonate as the organic solvent. Examples include ethylene carbonate, propylene carbonate, their derivatives, and any combinations and mixtures thereof as the organic solvent. Additional suitable solvents are cyclic ethers (e.g., tetrahydrofuran, tetrahydropyran, their derivatives, and any combinations thereof), glymes (e.g., dimethoxyethane, diethoxyethane, triglyme, tetraglyme, their derivatives, and any combinations thereof), and acyclic ether (e.g., diethylether, methybutylether, their derivatives, and any combinations thereof).

Further suitable electrolytes include those described in CN 103 531 839 A, WO 2014/065067 A1, US 2014/363746 A1, JP 2005 243321 WO 2014/126256 A1, US 2014/342241 A1, US 2012/258357 A1 and US 2012/244425 A1.

Particular useful electrolytes include lithium bis(fluorosulfonyl)imide (LiFSI) and sodium bis(fluorosulfonyl)imide (NaFSI), e.g., 5 M in dimethyl carbonate (DMC) and 7 M in dimethyl ether (DME).

An electrolyte at a high concentration (e.g., 3 M or greater, 5 M or greater, 2-12 M, 3-10 M, and 5-10 M) is included in the battery. It has been surprisingly discovered that limited or even negligible Li-ion de-intercalation during oxidation for all A₂MCl₄ compositions when the high concentration electrolyte is present. Strikingly, composition-and structure-dependent electrochemical behavior was observed upon reduction of the A₂MCl₄ phases, some phases undergoing conversion with limited reversibility while others show reversible cycling with low polarization. Combining electrochemical measurements with in situ XRD, ex situ HRTEM/EDS, and XPS experiments, low polarization reactivity of A₂MCl₄ compounds were observed and a displacement reaction was occurred. Further, also envisioned in this invention are sodium TM chloride compounds showing this reversible displacement reaction when cycled in superconcentrated Na-ion electrolyte.

By using high concentration electrolytes, the batteries of this invention utilize the electrochemical reactivity of ternary transition metal chlorides with the A₂MCl₄ stoichiometry. Dissolution of A₂MCl₄is suppressed. A displacement reaction preferably offers a significantly lower polarization between the reduction and oxidation reactions. During the low polarization plateau, TM nanoparticles are formed through a TM-deficient phase such as the A₆MCl₈intermediate. See below. Unlike a conversion reaction for which bonds are broken and reformed during the reaction, the displacement reaction is a topotactic reaction that shows a low polarization during galvanostatic cycling.

Not to be bound by any theory, it is believed that the reaction is a displacement reaction (Equation 1a) followed by conversion (Equation 1b) as shown below.

$${A}_{2} {TMCl}_{4} + {xA}^{+} + {xe}^{-} \to {A}_{2 + x} {TM}_{1 - 0.5 x} {Cl}_{4} + 1 / 2 xTM ; 0 < x < 1 \qquad ( 1 a )$$

$$1 / 2 {A}_{6} {TMCl}_{8} + {A}^{+} + {e}^{-} \to 1 / 2 TM + 4 ACl \qquad ( 1 b )$$

In the two equations above, A is Li or Na and TM can be Co or Mn.

Ternary alkali transition metal chlorides tend to undergo the above displacement reaction when they meet the following two criteria: (1) containing 1D chains of edge-sharing octahedra, and (2) having an available transition metal-deficient phase. Both Li₂CoCl₄ and Na₂MnCl₄ meet the two criteria.

Without further elaboration, it is believed that one skilled in the art can, based on the above description, utilize the present invention to its fullest extent. The examples below are to be construed as merely illustrative and not limitative in any way whatsoever.

All publications cited herein are hereby incorporated by reference in their entirety.

Set forth below are examples illustrating preparation and electrochemical property evaluation of A₂TMCl₄ electrode materials and batteries of this invention.

### EXAMPLES

### Chemicals

LiCl (99%, Thermo Scientific, Waltham, Massachusetts) and NaCl (99.5%, Thermo Scientific) were dried at 55° C. under vacuum at 50 mbar for 24 hours in a Buchi® glass oven before transferring into an argon-filled glovebox for further processing. Binary transition metal chloride precursors were used as received, including CrCl₂ (97%, Thermo Scientific), MnCl₂ (99.99% metals basis, Thermo Scientific), FeCl₂ (99.5% metals basis, Thermo Scientific), CoCl₂(97%, Sigma-Aldrich, St. Louis, MO), and CuCl₂ (99.995% metals basis, Thermo Scientific).

### Synthesis of A₂MCl₄ phases

Li₂MCl₄(M=Cr, Mn, Fe, Co) and Na₂MCl₄ were synthesized by mechanochemical synthesis using the binary chloride (MCl₂ ) mixed with LiCl or NaCl. A typical mechanochemical synthesis involved the following steps: (1) grind precursors using a mortar and pestle; (2) load the mixture into a hardened stainless steel ball mill vial (SPEX 8009SS); (3) ball mill for 10 cycles with 30 minutes of milling and 30 minutes of resting per cycle (SPEX 8000M mixer/miller); and (4) heat at 264° C. for 3 hours on a hotplate. See Tanibata et al., Advanced Energy and Sustainability Research 2020, 1 (1) available at DOI system following the address of//doi.org/10.1002/aesr.202000025. Steps 1, 2, and 4 were performed in an argon-filled glovebox (MBraun®, <0.5 ppm H₂O, O₂).

### Physical Characterization

X-ray diffraction (XRD) measurements were performed using a Bruker® D2 Phaser with Cu K_{α1}/K_{α2} incident X-rays (λ₁=1.5406 Å, λ₂=1.5444 Å). Samples for XRD were prepared in an argon-filled glovebox in an airtight sample holder (MTI Corporation) with a Kapton window. In situ XRD measurements were carried out using a coin cell with a Kapton window (TCH Instrument). A background curve was manually generated and either fit or subtracted from each pattern to account for the large background from the Kapton window. The collected diffraction patterns were analyzed using the Le Bail fitting method in the FullProf Suite (version 5.10, 2023).

Each pattern was fit with LiCl (Fm3̅m) structure and the respective Li₂MCl₄ structures reported in the Inorganic Crystal Structure Database (ICSD). Crystal structure illustrations were produced using VESTA. See Momma et al., J Appl Crystallogr 2011, 44 (6), 1272-1276 available at//doi.org/10.1107/S0021889811038970.

X-ray photoelectron spectroscopy (XPS) measurements were conducted on Thermo Fisher Scientific K-alpha instrument with an Al X-ray source. Pristine and ex situ powder samples were pressed into a copper holder and mounted in a vacuum transfer chamber in an argon-filled glovebox to avoid exposure to air and moisture. Data fitting and analysis was performed using Avantage software.

Transmission electron microscopy was performed on a Thermo Fisher Scientific Themis Z G3 Cs-corrected scanning transmission electron microscope equipped with a Super X-4 quadrant energy dispersive X-ray spectroscopy (EDS) detector. Samples were prepared by sonicating in hexanes for ˜30 minutes and drop casting on a copper grid coated with lacey carbon (Oxford Instruments). Sample grids were loaded in the Mel-Build Atmos Double Tilt LN2 Vacuum/Inert Gas Transfer Holder in a nitrogen-filled glovebox and transferred to the TEM without any air/moisture exposure. High-angle annular dark field images and EDS mapping data were collected at 200 kV.

### Electrochemical Characterization

Electrochemical measurements were performed using a Bio-Logic BCS-805 battery cycler. The active material was mixed with Super P carbon in a 7:3 weight ratio. Half cells were assembled using 2032 304 steel coin cells (TMAX) with aluminum foil coating the current collector at the positive electrode, followed by the active material powder mixture, glass fiber separators (Whatman), 100 μL of 5 M LiFSI in DMC (Solvionic), polished lithium metal (MTI) on a stainless steel spacer, and a stainless steel spring. The coin cells were crimped with a pressure of 0.8 tons. Powder processing was carried out in an argon-filled MBraun® Labstar Pro glovebox with <0.5 ppm O₂/H₂O. All coin cells were assembled in an argon-filled MBraun® Unilab Pro glovebox with <0.1 ppm O₂/H₂O. Unless otherwise stated, all galvanostatic cycling was conducted in a temperature control unit (Memmert) at a rate of C/10, with C referring to the exchange of 1 e⁻ per formula unit of the A₂MCl₄ compound. The C-rate was C/20 and rest time was 2 hours during the galvanostatic intermittent titration technique (GITT) measurements.

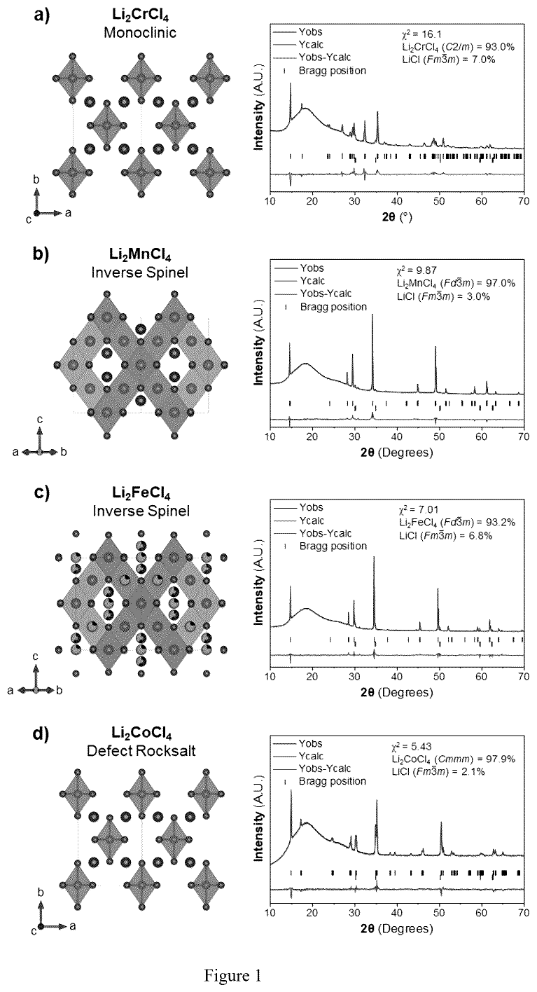

In A₂MCl₄ compounds, cations A and M occupy a combination of tetrahedral and octahedral positions in a close-packed anion sublattice. Owing to the nature of the metal-chloride bonds, a series of Li₂MCCl₄(M=Cr, Mn, Fe, Co) compounds, shown in FIG. 1, were synthesized via ball milling and subsequent mild heating at 264° C. Li₂CrCl₄ forms a monoclinic C2/m structure with 1-dimensional (1D) chains of edge-sharing CrCl₆ octahedra parallel to the c-axis. The CrCl₆ octahedral distortion leading to monoclinic symmetry is attributed to the Jahn-Teller effect. Li₂MnCl₄ and Li₂FeCl₄ both form cubic inverse spinel type (Fd3̅m) structures. In Li₂MnCl₄, half of the Li occupy the 8a tetrahedral position, while the other half share the 16d octahedral position with Mn. In Li₂FeCl₄, the 16d position is half lithium and half Fe, while the remaining lithium occupies 8a tetrahedral and 16c octahedral positions. Li₂CoCl₄ forms the orthorhombic (Cmmm) defect rock-salt structure. All Li and Co occupy octahedral positions, with the CoCl₆ octahedra forming 1D edge-sharing chains parallel to the c-axis. These four materials consist of two inverse spinel structures with 3D interconnected MCl₆ octahedra (Li₂MnCl₄ and Li₂FeCl₄) and two structures with 1D chains of MCl₆ octahedra (Li₂CrCl₄ and Li₂CoCl₄).

In a Galvanostatic cycling, Li₂CoCl₄ showed two plateaus in reduction. When the reduction was extended to 2 e⁻/f.u., a large hysteresis was observed between the reduction and oxidation curves. However, limiting the reaction to 1 e⁻/f.u. led to a lower hysteresis (360 mV).

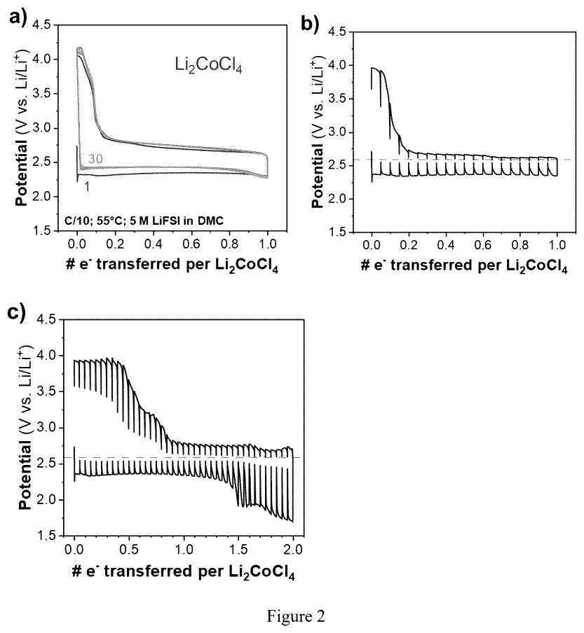

In the 1 e⁻/f.u. redox process, the results from extended galvanostatic cycling at 55° C. (FIG. 2a) reveal that Li₂CoCl₄ delivers a reversible capacity of 125 mAh g⁻¹ (1 e⁻/f.u.) at C/10.

Further, the discharge and charge profiles perfectly overlap one another, maintaining the low potential hysteresis and demonstrating that the material is stable and does not suffer from dissolution, phase transformations, or other parasitic reactions.

Galvanostatic intermittent titration technique (GITT) was used to reveal the equilibrium electrochemical potential of the material throughout reduction and oxidation. See FIG. 2a. The GITT results for Li₂CoCl₄ cycled at C/20 with 0.05 e⁻ increments and 2 hour rests at OCV between each step. When the GITT cycle was limited to 1 e⁻/f.u. (FIG. 2b), there was negligible hysteresis between the reduction plateau and the oxidation plateau. In the final stages of oxidation, the galvanostatic charging curve and the relaxation potential began to rise, which we attributed to some irreversibility in addition to electrolyte reactivity at potentials approaching 4 V vs. Li/Li⁺. The plateau voltage of 2.54 V vs. Li/Li⁺ aligns well with the expected reaction potential calculated for Co^{2+/0} redox (2.59 V vs. Li/Li⁺; see Table 1 for thermodynamic data). Reducing Li₂CoCl₄ beyond 1 e⁻/f.u. during GITT (FIG. 5c) requires a larger activation for the reaction to proceed, thus leading to higher polarization. However, the relaxation potential only very slightly changed from 2.54 V at 0.05 e⁻/f.u. to 2.43 V at 1.95 e⁻/f.u. Upon re-oxidation, a polarization of 140 mV is first observed after the exchange of 2 e⁻, compared to only 66 mV during the 1 e⁻ re-oxidation curve. At the end of the oxidation process, one new oxidation reaction pathway is recorded, showing high polarization and relaxation potentials in the range of 2.8-3.1V vs. Li/Li⁺, followed by a high potential region ≈3.8 V vs. Li/Li⁺ attributed to electrolyte reactivity (see discussion about anodic reactivity above). The conclusions from GITT results are that the reduction and oxidation reaction follow the same reaction path when the reduction is limited to 1 e⁻/f.u., while extending the reduction to reach 2 e⁻/f.u. shows similar relaxation potentials as the first plateau, attributed to the Co^{2+/0} redox couple.
Table 1. Thermodynamic data used to calculate the M^{2+/0} redox potentials for the transition metals used in this study based on the conversion reaction (MClₓ+xLi⁺+xe⁻=M+xLiCl, with x=2 for MCl₂ and x=1 for CuCl) of the binary chlorides.

| | ΔG_{f} | E(M^{2+/0}) | E(M^{2+/1+}) | E(M^{1+/0}) |
|---|---|---|---|---|
| Compound | kJ/mole | V vs. Li/Li⁺ | V vs. Li/Li⁺ | V vs. Li/Li⁺ |
| LiCl | −384.4 | — | — | — |
| CrCl₂ | −356.0 | 2.14 | — | — |
| MnCl₂ | −440.5 | 1.70 | — | — |
| FeCl₂ | −302.3 | 2.42 | — | — |
| CoCl₂ | −269.8 | 2.59 | — | — |
| CuCl₂ | −175.7 | 3.07 | 3.41 | — |
| CuCl | −119.9 | — | — | 2.74 |

Moreover, ex situ XPS experiments were carried out to understand the mechanism relating to the reactivity of Li₂CoCl₄ with Li, focusing on the oxidation state of Co upon reduction using the core spectrum of the Co 2p region in the pristine material and after 0.25, 0.5 and 1 e⁻ reduction. The spectrum of the pristine Li₂CoCl₄ shows two peaks corresponding to the 2p_{3/2} and 2p_{1/2} transitions at 780.9 and 797.2 eV, respectively, ascribed to Co(II). The peaks positioned at higher binding energy compared to the 2p_{3/2} and 2p_{1/2} peaks are the respective satellite peaks. The Co(II) signature was observed at all stages of reduction, as expected based on the reaction mechanism proposed above. However, a peak at 779 eV (highlighted in blue) corresponding to Co(0) emerged in the reduced samples as early as 0.25 e⁻/f.u. The intensity of the Co(0) peak increases with the degree of reduction from 0.25 to 1 e⁻/f.u. The results from ex situ XPS provide direct evidence that the electrochemical mechanism during the first reduction plateau of Li₂CoCl₄ involves the Co²⁺⁰ redox couple, therefore indirectly confirming the mechanism of Equations 1(a) and 1(b) above.

Further, in situ X-ray diffraction measurements were carried out during the first reduction and re-oxidation reaction. Peaks at 44.57 and 47.13° were observed upon reduction, and their peak intensities increased during reduction and decreased during oxidation. These peaks are attributed to the reversible formation/consumption of Co nanoparticles, in agreement with the results from XPS. During reduction, the intensity of the (201) peak of Li₂CoCl₄ at 35.18° decreases, but does not completely disappear, suggesting that a small amount of Li₂CoCl₄ is retained after 1 e⁻ reduction. This peak does not completely disappear until full reduction is reached, and only peaks associated with LiCl and Co nanoparticles are observed. A peak at 34.91° is found to increase in intensity during reduction. This peak can be associated with the formation of either Li₆CoCl₈ or LiCl. Nevertheless, these three compounds, Li₂CoCl₄, LiCl and Li₆CoCl₈, share similar anionic framework, with only slight differences in the cationic occupation of interstitial sites. Their diffraction peaks as described above are consistent with Equations 1(a) and (1b) proposed above.

TEM imaging coupled with EDS analysis was carried out to quantify the composition of Cl and Co in the phases present during cycling. The results show the ratio of Cl:Co in pristine Li₂CoCl₄ and 3 ex situ samples of Li₂CoCl₄ that underwent (1) reduction limited to 0.5 e⁻/f.u., (2) reduction limited to 1 e⁻/f.u., and (3) reduction limited to 0.5 e⁻/f.u. followed by oxidation with a potential limit of 3 V vs. Li/Li⁺. EDS mapping of pristine Li₂CoCl₄ reveals that Co and Cl are uniformly distributed throughout large micron scale particles, with the expected Cl:Co ratio of 4:1. After a reduction corresponding to the exchange of 0.5 e⁻, Co nanoparticles are observed, in agreement with the XPS and XRD results. Along with Co nanoparticles, regions with Cl:Co of 4:1 and 8:1 are observed. Notably, no regions of LiCl were observed at this early stage of the reduction process. Based on this analysis, we conclude that the reduction process proceeds following a displacement reaction and the formation of Li₆CoCl₈ intermediate along with Co(0) nanoparticles. For a sample that underwent reduction to 1 e⁻/f.u., Li₂CoCl₄ was no longer observed and regions of Co and Li₆CoCl₈ were once again observed, confirming that the reduction proceeds through a displacement reaction. Nevertheless, regions of LiCl are also observed, indicating that the onset of the conversion reaction is concomitant with the end of the displacement reaction. Confronting this observation with the electrochemical results gathered for different cells cycled under identical conditions, the onset of the second reduction plateau is observed between 0.8 and 1.2 e⁻/f.u. This indicates that the displacement reaction is sensitive on packing density, local current density and polarization, among other parameters, which can eventually be optimized by engineering means including by the use of coated electrodes, or by controlling the cell pressure. These results reveal that the reduction of Li₂CoCl₄ proceeds via the formation of a cobalt-deficient intermediate phase, Li₆CoCl₈.

The formation of cobalt nanoparticles and the cobalt-deficient phase, Li₆CoCl₈, observed via TEM/EDS, provides evidence that the reduction of Li₂CoCl₄ follows the displacement reaction (Equation 1a). Unlike conversion that is well-known to suffer from large polarization associated with the energy barrier to break and form metal-ligand and lithium-ligand bonds, the displacement reaction mechanism exhibits low hysteresis, while the polarization progressively increases from 1 to 2 e⁻ transferred per formula unit when the reaction mechanism switches to conversion. As for any displacement reaction, no bond must be broken during the reaction, and instead the intercalating cations simply displace another cation out of the structure upon its reduction. Hence, the displacement reaction is enabled by the structural similarities existing between the initial and the final product, i.e. between the chloride anion lattice in Li₂CoCl₄ and Li₆CoCl₈. Indeed, in Li₂CoCl₄, CoCl₆ octahedra have Cl—Co—Cl distances of 4.926 and 4.934 Å and Cl—Li—Cl distances of 5.101 and 5.145 Å. In Li₆CoCl₈, similar distances are observed, with Cl—Co—Cl distances of 4.890 Å and Cl—Li—Cl distances of 5.155 Å. Thus, no major volume expansion is observed during the displacement.

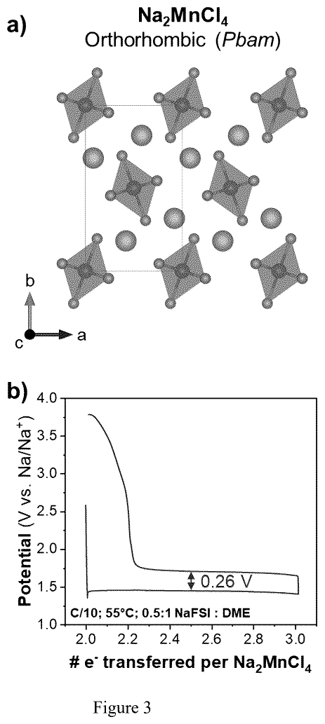

Preferably, Li₂-TM-Cl₄ compounds have the following two features: (1) the original structure contains 1D chains of edge-sharing octahedra (see FIGS. 3a), and (2) a TM-deficient intermediate is available with the same TM oxidation state. For Li₂CoCl₄, it has a 1D structure and also a TM-deficient intermediate, i.e., Li₆CoCl₈. In addition to Li₂CoCl₄, Na₂MnCl₄ also meets the two features, naming forming a structure with 1D chains of edge-sharing octahedra and has a TM-deficient intermediate, i.e., Na₆MnCl₈.

### Synthesis of NaMnCl₄

Na₂MnCl₄ was synthesized following a similar mechanochemical synthetic route, and its electrochemical reactivity was tested in a high concentration Na-ion electrolyte containing 7.25 M NaFSI in DME. FIG. 3b shows the galvanostatic cycling performance of Na₂MnCl₄ at a rate of C/10 and at 55° C. During the first cycle, a reversible low polarization plateau was observed when limited to 1 e⁻/f.u. The total potential hysteresis between discharge and charge was 0.26 V, which is lower than that of Li₂CoCl₄. The electrochemical behavior observed for Na₂MnCl₄ is characteristic of the displacement reaction, which is reversible with low polarization, a desirable property suitable for electrode materials.

### OTHER EMBODIMENTS

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. For example, compounds structurally analogous to the compounds of this invention also can be made, screened for their efficacy in treating cancer. Thus, other embodiments are also within the claims.

What is claimed is:

1. A battery comprising a positive electrode, a negative electrode, and an electrolyte, wherein
at least one of the positive electrode and the negative electrode contains a lithium or sodium compound of A₂MCl₄, in which A is Li or Na and Mis Ti, V, Cr, Mn, Fe, or Co, and
the electrolyte has a salt concentration of at least 3 mol/L.

2. The battery of claim 1, wherein the lithium or sodium compound has a monoclinic structure, a spinel structure, an inverse spinel structure, or a defect rock-salt structure, each of which contains transition metal-chloride polyhedra connected in 1-dimensional (1D) chains or 3D networks.

3. The battery of claim 2, wherein the lithium or sodium compound contains 1D chains of edge-sharing octahedra.

4. The battery of claim 1, wherein the lithium or sodium compound is Li₂VCl₄, Li₂FeCl₄, Li₂MnCl₄, Li₂CoCl₄, Li₂NiCl₄, Li₂CrCl₄, Na₂TiCl₄, Na₂FeCl₄, Na₂MnCl₄, Na₂CoCl₄, Na₂CoCl₄, or Na₂CrCl₄.

5. The battery of claim 4, wherein the lithium or sodium compound is Li₂CoCl₄ or Na₂MnCl₄.

6. The battery of claim 1, wherein the positive electrode or the negative electrode further contains A₆MCl₈ .

7. The battery of claim 6, wherein the positive electrode contains Li₂CoCl₄, Na₂MnCl₄, or a combination thereof.

8. The battery of claim 7, wherein the anode contains lithium, sodium, graphite, or any combination thereof.

9. The battery of claim 1, wherein the electrolyte contains a salt selected from the group consisting of LiClO₄, LiPF₆, LiBF₄, LiSbF₆, LiCF₃SO₃, LiN(SO₂CF₃)₂, LiN(SO₂C₂F₅)₂, LiN(SO₂F)₂, LiC(SO₂CF₃)₃, Li[N(SO₂C₄F₉)(SO₂F)], LiAlO₄, LiAlCl₄, LiCl, LiI, lithium bis(oxalato)borate, lithium bis(fluorosulfonyl)imide (LiFSI), NaClO₄, NaPF, NaBF₄, NaSbF₆, NaCF₃SO₃, NaN(SO₂CF₃)₂, NaN(SO₂C₂F₅)₂, NaN(SO₂F)₂, NaC(SO₂CF₃)₃, Na[N(SO₂C₄F₉)(SO₂F)], NaAlO₄, NaAlCl₄, NaCl, Nal, sodium bis(oxalato)borate, sodium bis(fluorosulfonyl)imide (NaFSI), or a combination thereof.

10. The battery of claim 9, wherein the salt is dissolved or suspended in a carbonate, an ether, an ester, a ketone, a nitrile, or a combination thereof.

11. The battery of claim 9, wherein the electrolyte is LiFSI or NaFSI dissolved in dimethyl carbonate (DMC) or dimethoxyethane (DME).

12. The battery of claim 11, wherein the electrolyte has a salt concentration of at least 4 mol/L.

13. The battery of claim 12, wherein the electrolyte has a salt concentration of 4.5 mol/L to 10 mol/L.

14. The battery of claim 9, wherein the positive electrode contains Li₂CoCl₄, Na₂MnCl₄, or a combination thereof.

15. The battery of claim 1, wherein the electrolyte is a lithium or sodium salt dissolved in a non-aqueous solvent having a salt concentration of at least 4 mol/L.

16. The battery of claim 15, wherein the electrolyte has a salt concentration of 4.5 mol/L to 10 mol/L.

17. The battery of claim 16, wherein the positive electrode contains Li₂CoCl₄, Na₂MnCl₄, or a combination thereof, and the anode contains lithium, sodium, graphite, or any combination thereof.

18. The battery of claim 17, wherein the non-aqueous solvent is a carbonate, an ether, an ester, a ketone, a nitrile, or a combination thereof.

19. The battery of claim 18, wherein the electrolyte is LiFSI or NaFSI dissolved in dimethyl carbonate (DMC) or dimethoxyethane (DME).

20. The battery of claim 1, wherein the battery is chargeable and dischargeable.
